(19) United States
(12) Patent Application Publication
(10) Pub. No.: US 2025/0008032 A1
(43) Pub. Date: Jan. 2, 2025

(54) INFORMATION PROCESSING SYSTEM, INFORMATION SYNCHRONIZATION SYSTEM, AND NON-TRANSITORY COMPUTER READABLE MEDIUM

(71) Applicant: FUJIFILM Business Innovation Corp., Tokyo (JP)

(72) Inventor: Seiji INOUE, Kanagawa (JP)

(73) Assignee: FUJIFILM Business Innovation Corp., Tokyo (JP)

(21) Appl. No.: 18/424,870

(22) Filed: Jan. 29, 2024

(30) Foreign Application Priority Data
Jun. 30, 2023 (JP) 2023-108942

(51) Int. Cl. H04N 1/00

(52) U.S. Cl. CPC H04N 1/00347; H04N 2201/0094

(57) ABSTRACT

An information processing system includes a processor configured to: if urgent situation information is acquired from a synchronization destination when a standard synchronization to synchronize information between the information processing system and the synchronization destination is performed by communicating with the synchronization destination at predetermined time intervals, transmit, to a second information processing system that performs the standard synchronization, an execution instruction that causes to be performed an urgent synchronization that, before a next standard synchronization is performed, communicates with the synchronization destination and synchronizes information with the synchronization destination.

### CROSS-REFERENCE TO RELATED APPLICATIONS

This application is based on and claims priority under 35 USC 119 from Japanese Patent Application No. 2023-108942 filed Jun. 30, 2023.

### BACKGROUND

### (i) Technical Field

The present disclosure relates to an information processing system, an information synchronization system, and a non-transitory computer readable medium.

### (ii) Related Art

Japanese Unexamined Patent Application Publication No. 2002-342201 discloses a pseudo-push type data delivery system. The pseudo-push type data delivery system includes a server and a client connected to each other via a network. In the pseudo-push type data delivery system, the client enquires of the server whether data to be delivered is present. Only if the data is present, the server delivers the data to the client. The pseudo-push type data delivery system thus makes it look like the server independently delivers the data to the client. If the data is present in the server, the server immediately delivers the data to the client and if no data is present in the server, the server returns, after a predetermined waiting time, a reply to the client that no data is present. Upon detecting an occurrence of data during the waiting time, the server delivers the data to the client.

If an information processing system performs only a standard synchronization that synchronizes information with a synchronization destination by communicating with the synchronization destination at predetermined time intervals, the information processing system may wait for the predetermined time interval even if information synchronization is to be urgently performed between the synchronization destination and the information processing system.

### SUMMARY

Aspects of non-limiting embodiments of the present disclosure relate to causing an information processing system, performing only a standard synchronization that synchronizes information with a synchronization destination by communicating with the synchronization destination at predetermined time intervals, to synchronize information between the synchronization destination and the information processing system without waiting for the predetermined time interval.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: if urgent situation information is acquired from a synchronization destination when a standard synchronization to synchronize information between the information processing system and the synchronization destination is performed by communicating with the synchronization destination at predetermined time intervals, transmit, to a second information processing system that performs the standard synchronization, an execution instruction that causes to be performed an urgent synchronization that, before a next standard synchronization is performed, communicates with the synchronization destination and synchronizes information with the synchronization destination.

### BRIEF DESCRIPTION OF THE DRAWINGS

Exemplary embodiment of the present disclosure will be described in detail based on the following figures, wherein:

FIG. 1 is a schematic diagram illustrating an information synchronization system of an exemplary embodiment;

FIG. 2 is a block diagram illustrating an example of a hardware configuration of a first multi-function apparatus of the exemplary embodiment;

FIG. 3 is a block diagram illustrating an example of a functional configuration of a controller of the first multi-function apparatus according to the exemplary embodiment;

FIG. 4 is a block diagram illustrating an example of a hardware configuration of a second multi-function apparatus according to the exemplary embodiment;

FIG. 5 is a block diagram illustrating an example of a functional configuration of the controller of the second multi-function apparatus according to the exemplary embodiment;

FIG. 6 is a block diagram illustrating an example of a hardware configuration of a cloud according to the exemplary embodiment;

FIG. 7 is a block diagram illustrating an example of a functional configuration of each element of the information synchronization system according to the exemplary embodiment;

FIG. 8 illustrates setting information when the first multi-function apparatus of the exemplary embodiment performs a standard synchronization;

FIG. 9 is a block diagram illustrating operations of elements in the information processing system when the first multi-function apparatus in the information processing system performs an urgent synchronization;

FIG. 10 illustrates a group member list that is set by grouping addresses of the first multi-function apparatus and the second multi-function apparatus in the information synchronization system of the exemplary embodiment;

FIG. 11 illustrates a synchronization time list of a group member of the exemplary embodiment;

FIG. 12 illustrates setting information including the group member list and synchronization time list;

FIG. 13 illustrates the setting information including urgent situation information;

FIG. 14 illustrates the setting information including the urgent situation information and additional information; and

FIG. 15 is a flowchart illustrating an example of a flow of a synchronization process of the exemplary embodiment.

### DETAILED DESCRIPTION

Embodiment of the disclosure is described below with reference to the drawings.

### Information Processing System 10

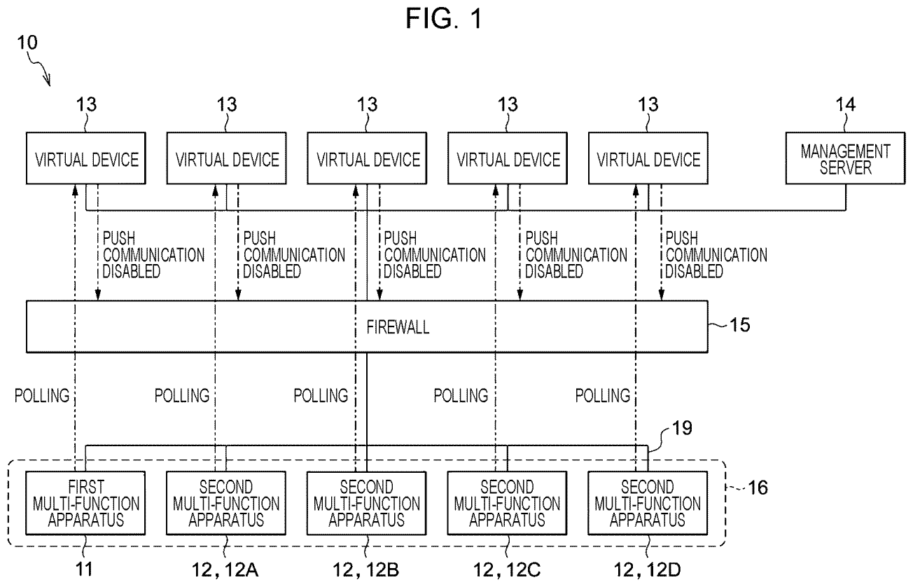

An information processing system 10 is described below. FIG. 1 is a schematic drawing of the information processing system 10 of the exemplary embodiment.

The information processing system 10 performs an information processing process including a synchronization process described below serving as a predetermined process and, as illustrated in FIG. 1, includes a first multi-function apparatus 11, multiple second multi-function apparatuses 12, cloud 14 and multiple virtual devices 13.

In other words, the information processing system 10 includes multiple (specifically, three or more) multiple apparatuses (specifically, the first multi-function apparatus 11 and multiple second multi-function apparatuses 12), cloud 14 and multiple (specifically, the same number as the number of multi-function apparatuses) virtual devices 13. The first multi-function apparatus 11, second multi-function apparatuses 12 and cloud 14 (the virtual device 13) are communicable with each other via a network. The elements of the information processing system 10 are described below.

### First Multi-function Apparatus 11

The first multi-function apparatus 11 that processes information is an example of a first information processing system. The first multi-function apparatus 11 may also be referred to as an information processing apparatus that processes information.

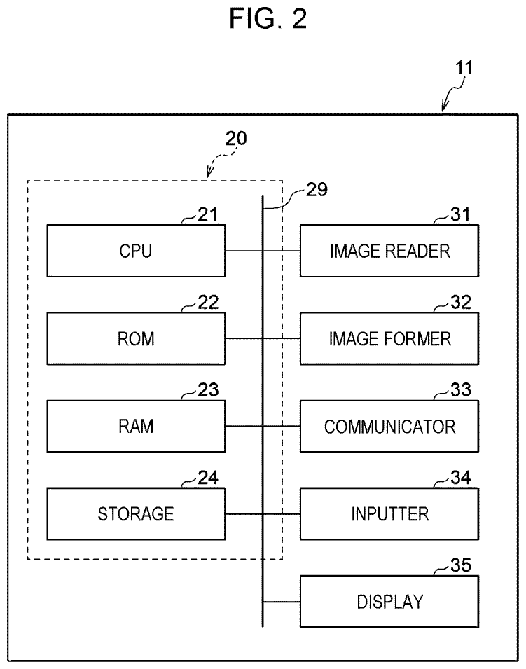

The first multi-function apparatus 11 is enabled to perform operations including a copying operation, printing operation, scanning operation and/or fax operation. Specifically, as illustrated in FIG. 2, the first multi-function apparatus 11 includes a controller 20, image reader 31, image former 32, communicator 33, inputter 34 and display 35.

The image reader 31 is an element (such as a scanner) that reads an image of an original document. The image reader 31 generates image data by optically reading the image of the original document and converting the read image into a digital signal. It is noted that the image includes characters.

The image former 32 forms an image on a recording medium, such as a paper sheet. The image former 32 forms the image on the recording medium through an electrophotographic system by performing operations including charging, exposure, development and fixing. The image former 32 may form the image on the recording medium through another system, such as an ink-jet system.

The communicator 33 communicates with other apparatuses, such as multiple, second multi-function apparatuses 12 and cloud 14 (the virtual device 13). Specifically, the communicator 33 communicates with the other apparatuses using communication system including a wired network, wireless network, Internet, intranet and/or public network, such as a telephone network. The communication system may be a communication medium using sound, light, vibration, image or the like.

According to the exemplary embodiment, the communicator 33 communicates with the cloud 14 (the virtual device 13) and second multi-function apparatuses 12 via different networks.

The communicator 33 communicates with the second multi-function apparatus 12 via a closed network 19 that a specific multi-function apparatus (an example of an information processing system) is connectable to. The network 19 is a network (such as a local area network (LAN)) into which a perimeter security system 15, such as firewall, is built. Communication performed between the communicator 33 and the second multi-function apparatus 12 (specifically, the communicator 233) may not involve verification of certificate. It is noted that FIG. 1 illustrates a firewall as an example of the perimeter security system.

According to the exemplary embodiment, the first multi-function apparatus 11 and the second multi-function apparatus 12 are connected to the closed network 19 to which a specific apparatus (an example of the information processing system) is connectable and form a group 16.

On the other hand, communication between the communicator 33 and the cloud 14 (the virtual device 13) involves the verification of certificate. Since the perimeter security system, such as the firewall, is used in the exemplary embodiment, push delivery from the cloud 14 (the virtual device 13) to the communicator 33 is not enabled. For this reason, pseudo push communication performing polling from the communicator 33 to the cloud 14 (the virtual device 13) is thus performed.

The pseudo push communication performs as described below a standard synchronization (specifically, the standard synchronization synchronizes information between the first multi-function apparatus 11 and the virtual device 13 by communicating with the virtual device 13 at predetermined time intervals).

The first multi-function apparatus 11 performs the scanning operation when the image reader 31 reads the image of the original document and generates image data. The first multi-function apparatus 11 performs the fax operation by transmitting, to another apparatus, such as another multi-function apparatus, the image data that the image reader 31 has generated by reading the image of the original document.

The first multi-function apparatus 11 performs the copying operation when the image former 32 forms an image on the recording medium, such as a paper sheet, in accordance with the image data that the image reader 31 has generated by reading the image of the original document. The first multi-function apparatus 11 performs the printing operation when the image former 32 forms an image on the recording medium, such as the paper sheet, in accordance with the image data that has been acquired from a terminal, such as a personal computer or a smart phone, or a memory medium, such as a universal serial bus (USB) memory.

The inputter 34 receives an instruction from a user. Specifically, the inputter 34 includes input keys (such as a keyboard or operation buttons), on which the user performs an entering operation, and touch panel.

Instructions from the user includes execution instructions causing the first multi-function apparatus 11 to perform jobs for the copying operation, printing operation, scanning operation and/or fax operation. The job refers to a process unit of operation to be performed by a single instruction of the user.

The display 35 is an example of a notifier and notifies the user of presentation information by displaying the presentation information to the user. For example, the display 35 may be a liquid-crystal display or an organic electroluminescence (EL) display.

The display 35 may function as the inputter 34. In such a case, the inputter may include a touch panel, such as a resistive film system or an electrostatic capacitance system, and receives an instruction from the user when the user performs a touching operation.

The controller 20 controls the elements of the first multi-function apparatus 11. The controller 20 has a function as a computer and as illustrated in FIG. 2, includes a central processing unit (CPU) 21, read-only memory (ROM) 22, random-access memory (RAM) 23 and storage 24. The CPU 21, ROM 22, RAM 23 and storage 24 are connected to each other via a bus 29.

The CPU 21 is a central processing unit, performs a variety of programs, such as information processing programs including an information synchronization program, and controls elements. The ROM 22 stores the variety of programs including an information processing program and a variety of data. The RAM 23 working as a working area store temporarily programs and data. The storage 24 includes a memory medium, such as a hard disk drive (HDD), solid-state drive (SSD) or a flash memory and stores a variety of programs including an operating system and a variety of data (for example, list information on destinations of the second multi-function apparatus 12). The information processing program may be stored on the storage 24.

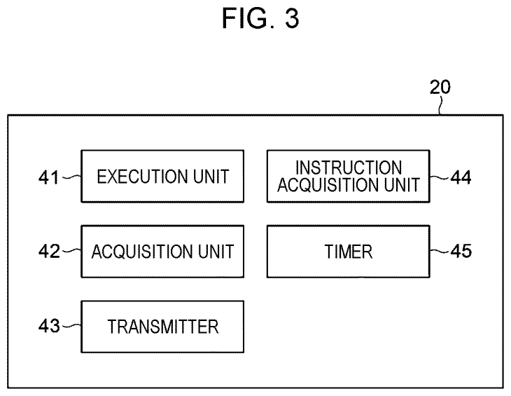

The CPU 21 in the controller 20 reads from the ROM 22 or the storage 24 the variety of programs including the information processing program and performs the read program using the RAM 23 as a working area. A variety of functions controlling elements of the first multi-function apparatus 11 are implemented when the CPU 21 performs the information processing program. The functional configuration implemented when the CPU 21 serving as a hardware resource and the information processing program serving as a software resource cooperate is described below. FIG. 3 is a block diagram illustrating an example of the functional configuration of the controller 20 of the first multi-function apparatus according to the exemplary embodiment.

The CPU 21 in the controller 20 performs the information processing program, thereby functioning as an execution unit 41, acquisition unit 42, transmitter 43, instruction acquisition unit 44 and timer 45 as illustrated in FIG. 3.

By communicating with the virtual device 13 at predetermined time intervals, the execution unit 41 performs a synchronization operation (hereinafter referred to as a standard synchronization) that synchronizes information between the first multi-function apparatus 11 and the virtual device 13. According to the exemplary embodiment, the timer 45 measures time and when an execution time comes, the timer 45 causes the execution unit 41 to start performing the standard synchronization. In this way, the execution unit 41 performs the standard synchronization by communicating with the virtual device 13 at predetermined constant time intervals (in other words, periodically). The execution unit 41 further performs the standard synchronization at a timing off a timing when the second multi-function apparatus 12 belonging to a group 16 performs the standard synchronization.

Synchronization signifies that information stored on the first multi-function apparatus 11 is caused to match information stored on the virtual device 13. According to the exemplary embodiment, a variety of information (such as parameter information) stored on the first multi-function apparatus 11 is caused to be stored on the virtual device 13 as well and the information stored on the virtual device 13 is updated such that a difference between the information stored on the first multi-function apparatus 11 and the information stored on the virtual device 13 is removed. It is noted that the information stored on the first multi-function apparatus 11 is updated such that a difference between the information stored on the first multi-function apparatus 11 and the information stored on the virtual device 13 is removed.

The acquisition unit 42 acquires urgent situation information from the virtual device 13 when the execution unit 41 has performed the standard synchronization. The acquisition unit 42 may acquire not only the urgent situation information but also additional information attached to the urgent situation information.

The urgent situation information is information that is transmitted from the virtual device 13 when the synchronization operation to synchronize information with the virtual device 13 (hereinafter referred to as “urgent synchronization”) is performed by communicating with the virtual device 13 before a next standard synchronization is performed. Specifically, the urgent situation information is transmitted to request the standard synchronization to be immediately performed.

The additional information includes a modification instruction to modify settings on the first multi-function apparatus 11 and the second multi-function apparatus 12, a certificate used in communication with the virtual device 13 and a rule used when the urgent synchronization is performed. The rule is an instruction that makes the timing of performing the urgent synchronization different from the second multi-function apparatus 12 to another second multi-function apparatus 12.

If the acquisition unit 42 acquires the urgent situation information with the execution unit 41 performing the standard synchronization, the transmitter 43, before performing a next standard synchronization, transmits to the second multi-function apparatus 12 an execution instruction to cause the urgent synchronization to be performed. According to the exemplary embodiment, if the acquisition unit 42 acquires the urgent situation information with the execution unit 41 performing the standard synchronization, the transmitter 43, before performing the next standard synchronization, transmits to the second multi-function apparatus 12 belonging to the group 16 the execution instruction to cause the urgent synchronization to be performed.

If the acquisition unit 42 has acquired the urgent situation information and the additional information added to the urgent situation information, the transmitter 43 transmits to the second multi-function apparatus 12 the additional information together with the execution instruction used to cause the urgent synchronization to be performed.

The acquisition unit 44 acquires from the second multi-function apparatus 12 the execution instruction causing the urgent synchronization to be performed. If the acquisition unit 44 has acquired from the second multi-function apparatus 12 the execution instruction causing the urgent synchronization to be performed, the execution unit 41 performs the urgent synchronization.

If the acquisition unit 42 acquires the urgent situation information from the virtual device 13 with the execution unit 41 performing the standard synchronization and the execution instruction causing the urgent synchronization on the urgent situation information to be performed is acquired from the second multi-function apparatus 12, the execution unit 41 does not perform the urgent synchronization.

### Second Multi-Function Apparatus 12

The second multi-function apparatus 12 is an example of another information processing system that processes information and is also an example of a second information processing system. The second multi-function apparatus 12 may be referred to as an information processing apparatus that processes information. If one second multi-function apparatus 12 is another information processing system, a second multi-function apparatus 12 other than the one second multi-function apparatus 12 may be referred to as a different information processing system.

The second multi-function apparatus 12 is identical in configuration to the first multi-function apparatus 11 and is able to perform the copying operation, printing operation, scanning operation and/or fax operation. The following discussion focuses on portions of the second multi-function apparatus 12 different from the first multi-function apparatus 11 and identical portions may be briefly discussed or may not be discussed at all.

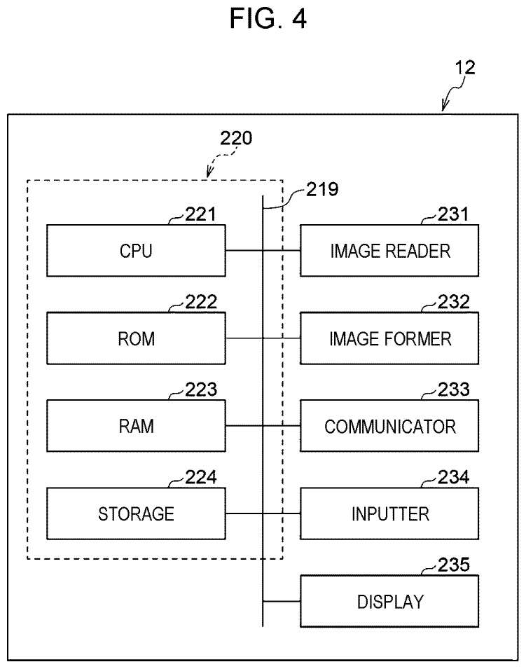

Specifically, as illustrated in FIG. 4, the second multi-function apparatus 12 includes a controller 220, image reader 231, image former 232, communicator 233, inputter 234 and display 235.

The controller 220 operates as a computer and, as illustrated in FIG. 4, includes a CPU 221, ROM 222, RAM 223 and storage 224. The CPU 221, ROM 222, RAM 223 and storage 224 are interconnected to each other via a bus 219.

The controller 220, image reader 231, image former 232, communicator 233, inputter 234, display 235, CPU 221, ROM 222, RAM 223, storage 224 and bus 219 in the second multi-function apparatus 12 are respectively identical in configuration to the controller 20, image reader 31, image former 32, communicator 33, inputter 34, display 35, CPU 21, ROM 22, RAM 23, storage 24 and bus 29 in the first multi-function apparatus 11.

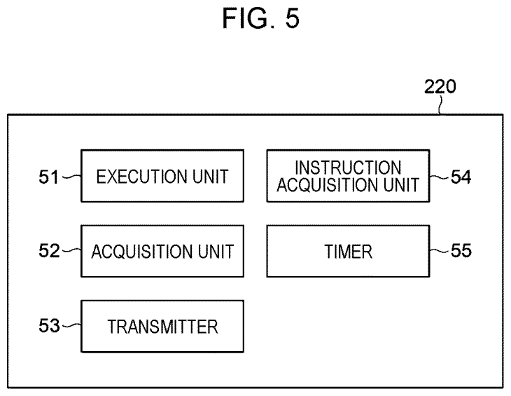

The CPU 221 in the controller 220 operates as an execution unit 51, acquisition unit 52, transmitter 53, instruction acquisition unit 54 and timer 55 as illustrated in FIG. 5.

The execution unit 51, acquisition unit 52, transmitter 53, instruction acquisition unit 54 and timer 55 are respectively identical in operation to the execution unit 41, acquisition unit 42, transmitter 43, instruction acquisition unit 44 and timer 45 in the first multi-function apparatus 11.

According to the exemplary embodiment, for convenience of discussion, from among multiple multi-function apparatuses, a multi-function apparatus having received the urgent situation information is set to be the first multi-function apparatus 11 and a multi-function apparatus to which the first multi-function apparatus 11 transmits the execution instruction causing the urgent synchronization to be performed is set to be the second multi-function apparatus 12. It is noted, however, that the first multi-function apparatus 11 and second multi-function apparatus 12 are identical to each other as a multi-function apparatus. One second multi-function apparatus 12 may operate as a multi-function apparatus having acquired the urgent situation information and, a second multi-function apparatus 12 other than the one second multi-function apparatus 12 and the first multi-function apparatus 11 may operate as multi-function apparatuses to which the one second multi-function apparatus 12 transmits the execution instruction causing the urgent synchronization to be performed.

### Cloud 14 and Virtual Device 13

As described above, the cloud 14 is communicable with the first multi-function apparatus 11 and the second multi-function apparatus 12 and is an apparatus that provides a variety of services. The cloud 14 may be a management server that manages the information processing system 10.

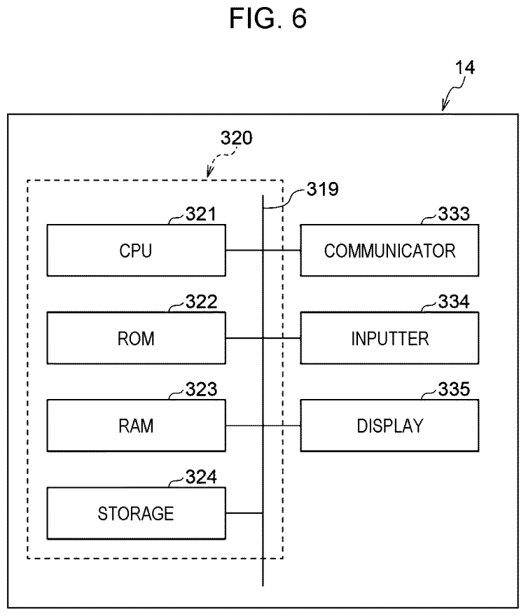

Specifically, as illustrated in FIG. 6, the cloud 14 includes a controller 320, communicator 333, inputter 334 and display 335.

The controller 320 operates as a computer and, as illustrated in FIG. 6, includes a CPU 321, ROM 322, RAM 323 and storage 324. The CPU 321, ROM 322, RAM 323 and storage 324 are interconnected to each other via a bus 319.

The controller 320, communicator 333, inputter 334, display 335, CPU 321, ROM 322, RAM 323, storage 324 and bus 319 in the cloud 14 are respectively identical in configuration to the controller 20, communicator 33, inputter 34, display 35, CPU 21, ROM 22, RAM 23, storage 24 and bus 29 in the first multi-function apparatus 11.

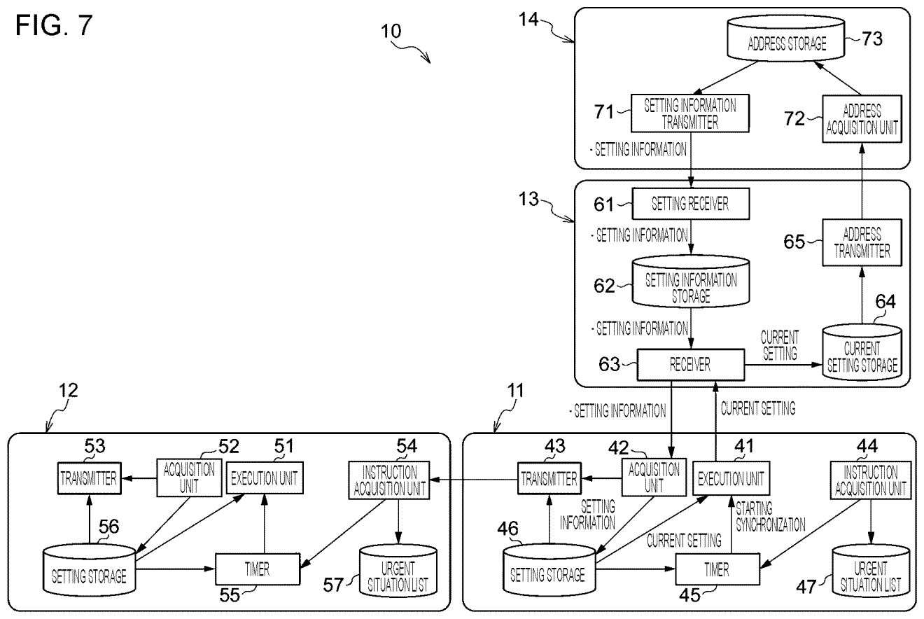

The CPU 321 in the controller 320 operates as a setting information transmitter 71 and address acquisition unit 72 as described below by performing the information processing program (see FIG. 7).

The virtual device 13 is an example of a synchronization destination. The virtual device 13 is virtually constructed over the cloud 14. The virtual device 13 is communicable with the first multi-function apparatus 11 and the second multi-function apparatus 12 and is able to transmit and receive information. Specifically, the virtual device 13 is constructed as a digital twin of each of the first multi-function apparatus 11 and the multi-function apparatus 12 and synchronizes information with the first multi-function apparatus 11 and second multi-function apparatus 12.

The virtual device 13 includes as functional elements a setting receiver 61, setting information storage 62, receiver 63, current setting storage 64 and address transmitter 65 as described below (see FIG. 7). For example, the setting information storage 62 and current setting storage 64 are configured on a storage 324.

### Standard Synchronization in Information Processing System 10

A process of elements of the first multi-function apparatus 11 in the information processing system 10 in the standard synchronization are described below. The process includes a pre-process that is performed prior to the standard synchronization.

When the administrator (specifically, an operator) of the cloud 14 determines setting contents to be applied to the first multi-function apparatus 11 and second multi-function apparatus 12 and enters setting information indicating the setting contents to the setting information transmitter 71 of the cloud 14, the setting information transmitter 71 transmits the setting information to the setting receiver 61 of the virtual device 13 as illustrated in FIG. 7.

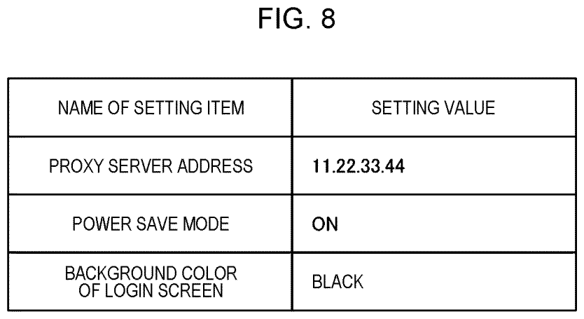

The setting information includes, for example, information related to a proxy server address, on/off of a power save mode and background color of a login screen. The setting information is not limited to information illustrated in FIG. 8 and may include information related to a variety of setting contents.

When the setting information is received from the setting information transmitter 71 as illustrated in FIG. 7, the setting receiver 61 of the virtual device 13 causes the setting information storage 62 to store the setting information. The setting information is thus stored on the setting information storage 62.

On the other hand, the timer 45 in the first multi-function apparatus 11 measures time and when execution time to perform the standard synchronization comes, the execution unit 41 is caused to start performing the standard synchronization. The execution unit 41 thus performs the standard synchronization by communicating with the receiver 63 in the virtual device 13 at constant time intervals (specifically, periodically). It is noted that the timer 45 causes the execution unit 41 to perform the standard synchronization, for example, once every three hours.

The receiver 63 retrieves the setting information from the setting information storage 62 and then transmits the setting information to the acquisition unit 42. Specifically, the receiver 63 performs pseudo push communication involving polling.

The acquisition unit 42 acquires the setting information and then writes the setting information onto the setting storage 46. The setting on the first multi-function apparatus 11 is thus modified.

The execution unit 41 reads a current setting from the setting storage 46 and transmits the read current setting to the receiver 63.

The receiver 63 acquires the current setting from the execution unit 41 and causes the current setting storage 64 to store the current setting. The current setting is thus stored on the current setting storage 64. The current setting is all the setting information that the first multi-function apparatus 11 stores at the moment when the receiver 63 receives the current setting. The format of the setting information is identical to the setting information previously described and includes the name of the setting item and setting value.

### Urgent Synchronization in Information Processing System 10

The process performed in the urgent synchronization by the first multi-function apparatus 11 in the information processing system 10 is described below. The process includes a pre-process that is performed prior to the execution of the urgent synchronization.

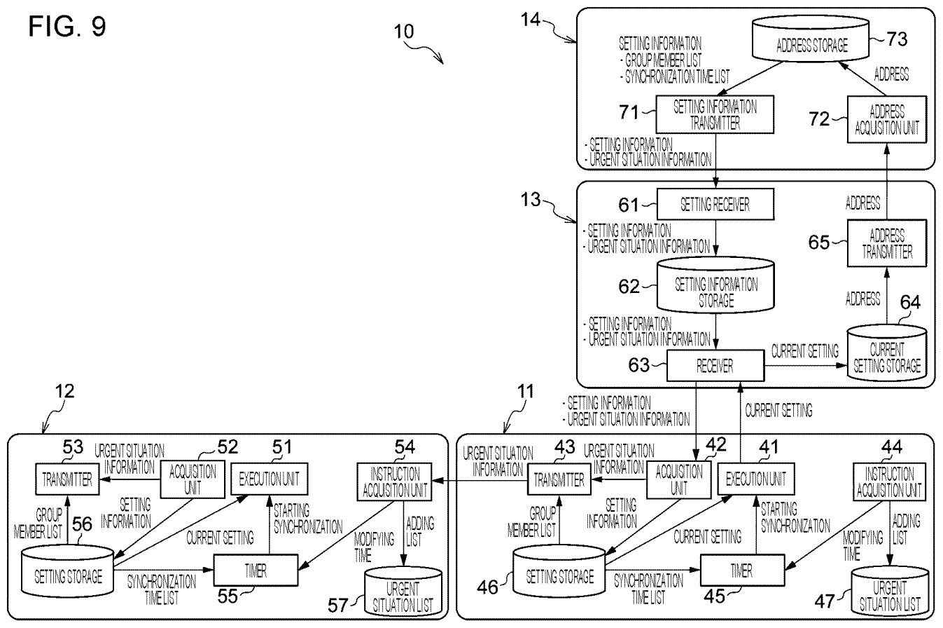

The address transmitter 65 in the virtual device 13 acquires an address of the first multi-function apparatus 11 (for example, IPv4 address) from the current setting storage 64 and transmits the address of the first multi-function apparatus 11 to the address acquisition unit 72 in the cloud 14 as illustrated in FIG. 9. Upon acquiring the address of the first multi-function apparatus 11, the address acquisition unit 72 stores the address onto the address storage 73. The address of the first multi-function apparatus is thus stored on the address storage 73 11. For example, the address storage 73 is configured on the storage 324.

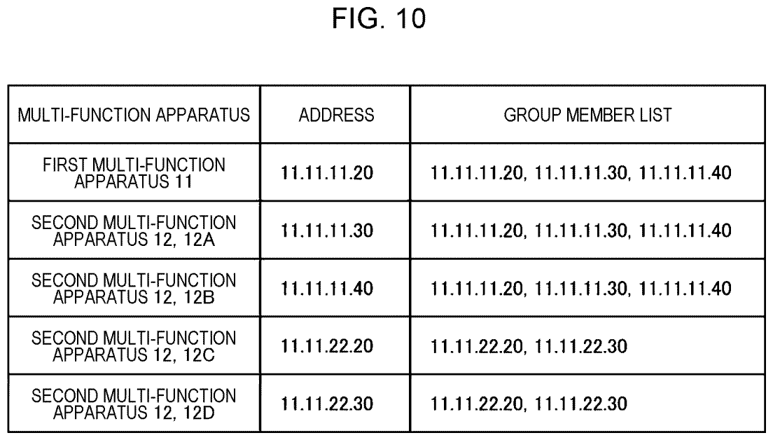

The address acquisition unit 72 acquires from all the virtual devices 13 the addresses of the first multi-function apparatus 11 and the second multi-function apparatuses 12 and causes the address storage 73 to store the addresses. Specifically, the address acquisition unit 72 groups the addresses of the first multi-function apparatus 11 and the second multi-function apparatuses 12 and then causes the address storage 73 to store the grouped addresses. The address storage 73 stores a group member list (see FIG. 10) that is set up by grouping the addresses of the first multi-function apparatus 11 and the second multi-function apparatuses 12.

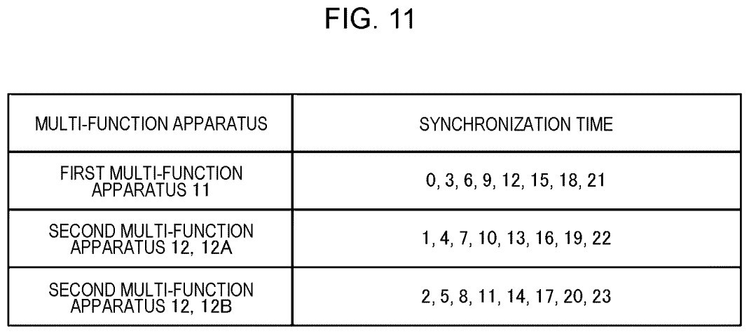

The address storage 73 stores a synchronization time list of each group member (see FIG. 11). The synchronization time list indicates time (specifically, timing) at which each of the multi-function apparatuses (the first multi-function apparatus 11 and the second multi-function apparatuses 12) forming the group members performs the standard synchronization. The time is set in the group member list such that the standard synchronization is performed at mutually different timings from one multi-function apparatus to another multi-function apparatus serving as the group members.

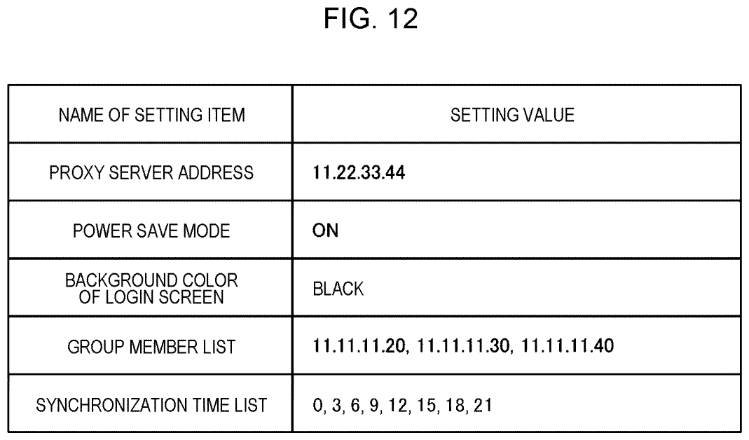

If the group member list and synchronization time list have been set up, the setting information transmitter 71 transmits to the setting receiver 61 of the virtual device 13 information on the group member list and synchronization time list as the setting information (see FIG. 12). The group member list and synchronization time list may be created and set up by the administrator of the cloud 14.

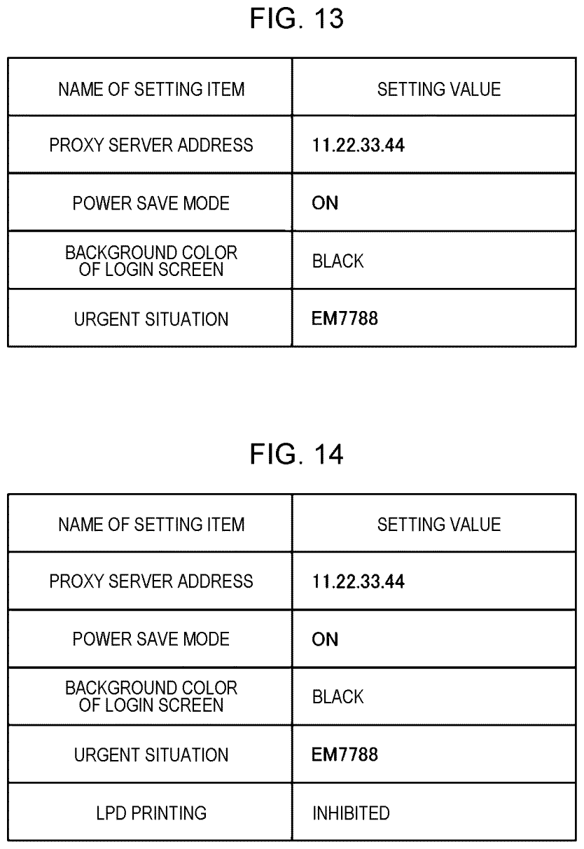

Upon acquiring a transmission instruction to transmit the urgent situation information from the administrator of the cloud 14 (namely, the operator), the setting information transmitter 71 transmits not only the setting information but also the urgent situation information to the setting receiver 61 of the virtual device 13 as illustrated in FIG. 9. The information transmitted to the setting receiver 61 includes the setting information and urgent situation information as illustrated in FIG. 13. The urgent situation information is attached with identification information used to identify the urgent situation information. The identification information is a character string “EM7788” in FIG. 13. The identification information is used in each of the multi-function apparatuses (the first multi-function apparatus 11 and the second multi-function apparatuses 12) such that multiple synchronization operations are not performed multiple times in response to a single piece of urgent situation information.

In response to the reception of the setting information and urgent situation information from the setting information transmitter 71, the setting receiver 61 causes the setting information storage 62 to store the setting information and urgent situation information. The setting information and urgent situation information are thus stored on the setting information storage 62.

When the execution unit 41 in the first multi-function apparatus 11 has performed the standard synchronization, the receiver 63 retrieves the setting information and urgent situation information from the setting information storage 62 and then transmits the setting information and urgent situation information to the acquisition unit 42.

The acquisition unit 42 acquires the setting information and urgent situation information and writes the setting information onto the setting storage 46. The setting on the first multi-function apparatus 11 is thus modified. It is noted that the setting storage 46 and the urgent situation list 47 are configured on the storage 24.

Having acquired the urgent situation information, the transmitter 43 transmits an execution instruction to cause the urgent synchronization (specifically, the urgent situation information) to be performed to the instruction acquisition unit 54 in the second multi-function apparatus 12 before a next standard synchronization is performed. The transmitter 43 then reads the group member list from the setting storage 46 and then transmits the urgent situation information to the instruction acquisition unit 54 in the second multi-function apparatus 12 having an address other than an address of the first multi-function apparatus 11.

Having acquired the urgent situation information, the instruction acquisition unit 54 determines whether the urgent situation information having the same character string is present in the urgent situation list 57. If the urgent situation information having the same character string is present in the urgent situation list 57, nothing is performed on the urgent situation list 57 because the urgent situation list 57 has been dealt with. On the other hand, if the urgent situation information having the same character string is not present in the urgent situation list 57, the instruction acquisition unit 54 stores the urgent situation information as the character string in the urgent situation list 57 and requests the timer 55 to carry out the start instruction to start synchronization with the execution unit 51. The timer 55 causes the execution unit 51 to immediately start the urgent synchronization. It is noted that the setting storage 56 and urgent situation list 57 are configured on the storage 224.

As described previously, the additional information may be added to the urgent situation information. The additional information may include a modification instruction to modify the setting on the first multi-function apparatus 11 and the second multi-function apparatuses 12, certificate used in communication with the virtual device 13 and rule used when the urgent synchronization is performed.

The modification instruction may be a setting instruction, such as “LPD printing inhibited” as illustrated in FIG. 14.

The certificate is issued to control the communication of each of the multi-function apparatuses (the first multi-function apparatus 11 and the second multi-function apparatus 12) with a wrong virtual device 13 and certifies that the multi-function apparatus is an apparatus serving as a synchronization partner of the virtual device 13.

The rule is, for example, an instruction that makes the timing of performing the urgent synchronization from one second multi-function apparatus 12 to another second multi-function apparatus 12. Specifically, the instruction makes the second multi-function apparatuses 12 perform the urgent synchronization at different timings.

### Process Flow of First Multi-function Apparatus 11 in Information Processing System 10

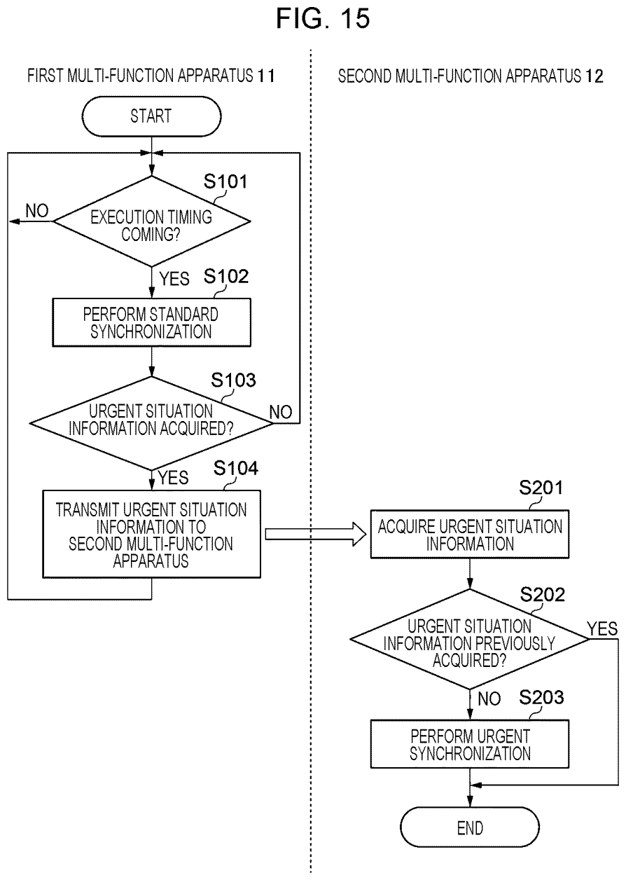

A process flow of a synchronization process performed by the first multi-function apparatus 11 in the information processing system 10 is described below. FIG. 15 is a flowchart illustrating an example of the flow of the synchronization process of the exemplary embodiment.

When the first multi-function apparatus 11 in the information processing system 10 is powered on and starts operating, the synchronization process starts. According to the exemplary embodiment, the CPU 21 in the first multi-function apparatus 11 reads the information synchronization program from the ROM 22 or storage 24, the CPU 221 in the second multi-function apparatus 12 reads the information synchronization program from the ROM 222 or storage 224, and the CPU 21 and CPU 221 perform the information synchronization program in cooperation with each other and thus perform the synchronization process.

When the synchronization process starts, the CPU 21 determines as illustrated in FIG. 15 whether an execution timing to execute the standard synchronization has come (step S101). Specifically, the CPU 21 determines whether the timer 45 has notified the execution unit 41 of synchronization start. Determining that the execution timing to execute the standard synchronization has not come (no path in step S101), the CPU 21 repeats the operation in step S101.

Determining that the execution timing to execute the standard synchronization has come (yes path in step S101), the CPU 21 performs the standard synchronization (step S102). Specifically, the CPU 21 performs the standard synchronization at a timing off a timing when the second multi-function apparatus 12 belonging to the group 16 performs the standard synchronization.

When the standard synchronization is performed, the CPU 21 determines whether the urgent situation information has been acquired (step S103). Specifically, the CPU 21 determines whether the acquisition unit 42 has acquired the urgent situation information from the receiver 63. Determining in the standard synchronization that the urgent situation information has not been acquired (no path in step S103), the CPU 21 returns to step S101.

Determining in the standard synchronization that the urgent situation information has been acquired (yes path in step S103), the CPU 21 transmits, before performing a next standard synchronization, the urgent situation information to cause the second multi-function apparatus 12 belonging to the group 16 to perform the urgent synchronization (step S104) and then returns to step S101.

If the urgent situation information and the additional information added thereto are acquired, the CPU 21 transmits not only the urgent situation information but also the additional information to the second multi-function apparatus 12 belonging to the group 16.

The CPU 221 in the second multi-function apparatus 12 acquires the urgent situation information (step S201) and then determines whether the same urgent situation information has been received (step S202). Determining that the same urgent situation information has not been received (no path in step S202), the CPU 221 performs the urgent synchronization (step S203) and then ends the synchronization process on the second multi-function apparatus 12.

Determining that the same urgent situation information has been acquired (yes path in step S202), the CPU 221 does not perform the urgent synchronization and ends the synchronization process on the second multi-function apparatus 12.

### Process of Exemplary Embodiment

According to the exemplary embodiment, if the urgent situation information is acquired in the standard synchronization, the CPU 21, before performing a next standard synchronization, transmits to the second multi-function apparatus 12 the execution instruction to cause the urgent synchronization to be performed (see step S104). Determining that the same urgent situation information has not been received (no path in step S201), the CPU 221 in the second multi-function apparatus 12 performs the urgent synchronization.

According to the exemplary embodiment, the second multi-function apparatus 12 performs the standard synchronization that synchronizes information with the virtual device 13 by communicating with the virtual device 13 at predetermined time intervals and the second multi-function apparatus 12 may thus be caused to synchronize information with the virtual device 13 without waiting for the predetermined time interval.

Specifically, according to the exemplary embodiment, the execution instruction to cause the urgent synchronization to be performed is transmitted to, before a next standard synchronization is performed, the second multi-function apparatus 12 forming the group 16 and connected to the closed network 19 to which a specific multi-function apparatus (an example of an information processing system) is connectable (see step S104).

In this way, the second multi-function apparatus 12 belonging to the group 16 may synchronize information with the virtual device 13 without waiting for the predetermined time interval.

Specifically, the CPU 21 performs the standard synchronization at a timing off a timing when the second multi-function apparatus 12 belonging to the group 16 performs the standard synchronization (see step S102).

In comparison with the case where the CPU 21 performs the standard synchronization at the same timing as the timing when the second multi-function apparatus 12 belonging to the group 16 performs the standard synchronization, a time interval that allows the urgent situation information to be acquired in the group 16 is short. As a result, the waiting time of the second multi-function apparatus 12 until the synchronization of the information with the virtual device 13 may be shorter.

According to the exemplary embodiment, the CPU 21 performs the urgent synchronization if the execution instruction to cause the urgent synchronization to be performed is received from the second multi-function apparatus 12.

In comparison with the case where the CPU 21 performs only the transmission of the execution instruction to cause the second multi-function apparatus 12 to perform the urgent synchronization, the waiting time of the first multi-function apparatus 11 until the synchronization of information with the virtual device 13 may be shorter.

Specifically, according to the exemplary embodiment, if the urgent situation information is acquired from the virtual device 13 in the standard synchronization and the execution instruction causing the urgent synchronization related to the urgent situation information to be performed is received from the second multi-function apparatus 12, the CPU 21 does not perform the urgent synchronization.

In comparison with the case where the CPU 21 normally performs the urgent synchronization in response to the acquisition of the execution instruction from the second multi-function apparatus 12, performing the same urgent synchronization multiple times may be controlled.

According to the exemplary embodiment, if the urgent situation information and the additional information added to the urgent situation information are acquired, the CPU 21 transmits to the second multi-function apparatus 12 not only the execution instruction to cause the urgent synchronization to be performed but also the additional information.

In comparison with the case where the CPU 21 normally transmits only the execution instruction to the second multi-function apparatus 12, the CPU 21 may thus perform not only the urgent synchronization on the second multi-function apparatus 12 but also an operation related to the additional information.

The additional information is, for example, a modification instruction to modify the setting on the first multi-function apparatus 11 and second multi-function apparatus 12. In such a case, the second multi-function apparatus 12 may be allowed to modify the setting prior to the execution of the urgent synchronization.

The additional information is, for example, a certificate used in communication with the virtual device 13. In such a case, a failure to perform the urgent synchronization due to a defect in the certificate of the second multi-function apparatus 12 may be controlled.

The additional information is, for example, a rule used to perform the urgent synchronization. In such a case, the rule may be set up when the second multi-function apparatus 12 performs the urgent synchronization.

The rule is, for example, an instruction that makes the timing of performing the urgent synchronization from the second multi-function apparatus 12 to another second multi-function apparatus 12. In such a case, the simultaneous occurrence of the urgent synchronization may be controlled when the second multi-function apparatuses 12 perform the urgent synchronization.

### Modifications

According to the exemplary embodiment, examples of the information processing system are multi-function apparatuses (specifically, the first multi-function apparatus 11 and the second multi-function apparatuses 12). The disclosure is not limited to this configuration. For example, the information processing system may be a printer that performs only the printing operation or an image forming apparatus other than the multi-function apparatus. The information processing system is not limited to the image forming apparatus and may be any apparatus having communication capability, such as a terminal, like a personal computer or a smart phone.

According to the exemplar embodiment, before a next standard synchronization is performed, the CPU 21 transmits to the second multi-function apparatus 12 belonging to the group 16 the execution instruction to cause the urgent synchronization to be performed. The disclosure is not limited to this configuration. The CPU 21 may transmit the execution instruction to a second multi-function apparatus 12 not belonging to the group 16.

According to the exemplary embodiment, the CPU 21 performs the standard synchronization at the timing off the timing when the second multi-function apparatus 12 belonging to the group 16 performs the standard synchronization (see step S102). The disclosure is not limited to this configuration. The CPU 21 may perform the standard synchronization at the same timing as the timing when a subset of second multi-function apparatuses 12, from among the second multi-function apparatuses 12 belonging to the group 16, performs the standard synchronization (see step S102).

According to the exemplary embodiment, the CPU 21 performs the urgent synchronization if the execution instruction to cause the urgent synchronization to be performed is received from the second multi-function apparatus 12. The disclosure is not limited to this configuration. For example, the CPU 21 may perform only the transmission of the execution instruction to cause the second multi-function apparatus 12 to perform the urgent synchronization.

According to the exemplary embodiment, if the urgent situation information is acquired from the virtual device 13 in the standard synchronization and the execution instruction to cause the urgent synchronization related to the urgent situation information to be performed is received from the second multi-function apparatus 12, the CPU 21 does not perform the urgent synchronization. The disclosure is not limited to this configuration. For example, the CPU 21 may normally perform the urgent synchronization if the execution instruction is received from the second multi-function apparatus 12.

According to the exemplary embodiment, the CPU 21 transmits to the second multi-function apparatus 12 not only the execution instruction to cause the urgent synchronization to be performed but also the additional information if the urgent situation information and the additional information added to the urgent situation information are received. The disclosure is not limited to this configuration. For example, the CPU 21 may be configured to normally transmit only the execution instruction to the second multi-function apparatus 12.

The disclosure is not limited to the exemplary embodiment and a variety of changes, modifications, and improvements may be possible without departing from the scope of the disclosure. For example, the modifications described above may be appropriately combined.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

According to the exemplary embodiment, the information processing system includes multiple apparatuses but alternatively, may include only a single apparatus. According to the exemplary embodiment, the information processing system includes a single apparatus but alternatively the information processing system may include multiple apparatuses. In other words, the term “system” in the exemplary embodiment may include a single apparatus or multiple apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
a processor configured to:
   if urgent situation information is acquired from a synchronization destination when a standard synchronization to synchronize information between the information processing system and the synchronization destination is performed by communicating with the synchronization destination at predetermined time intervals,
   transmit, to a second information processing system that performs the standard synchronization, an execution instruction that causes to be performed an urgent synchronization that, before a next standard synchronization is performed, communicates with the synchronization destination and synchronizes information with the synchronization destination.
      (((2)))

In the information processing system according to (((1))), the information processing system forms a group with the second information processing system connected to a closed network that a specific information processing system is connectable to, and
wherein the processor is configured to:
   if the urgent situation information is acquired from the synchronization destination with the standard synchronization performed,
   transmit the execution instruction via the network to the second information processing system belonging to the group.
      (((3)))

In the information processing system according to (((2))), the processor is configured to: perform the standard synchronization at a timing off a timing when the second information processing system belonging to the group performs the standard synchronization.

(((4)))

In the information processing system according to one of (((1))) through (((3))), the processor is configured to:
perform the urgent synchronization if the execution instruction to cause the urgent synchronization to be performed is acquired from the second information processing system that executes the standard synchronization.
   (((5)))

In the information processing system according to one of (((1))) through (((4))), the processor is configured to:
if the urgent situation information is acquired from the synchronization destination with the standard synchronization performed,
not perform the urgent synchronization when the execution instruction related to the urgent situation information is acquired from the second information processing system that performs the standard synchronization.
   (((6)))

In the information processing system according to one of (((1))) through (((5))), the processor is configured to:
if the urgent situation information and additional information added to the urgent situation information are acquired from the synchronization destination with the standard synchronization performed,
transmit the additional information together with the execution instruction to the second information processing system.
   (((7)))

In the information processing system according to (((6))), the additional information is a modification instruction to modify a setting on the information processing system.

(((8)))

In the information processing system according to (((6))), the additional information is a certificate used in communication with the synchronization destination.

(((9)))

In the information processing system according to (((6))), the additional information is a rule used to perform the urgent synchronization.
(((10)))

In the information processing system according to (((9))), the rule is an instruction to make a timing of performing the urgent synchronization different from the second information processing system to an information processing system different from the second information processing system.

(((11)))

An information synchronization system including:
a synchronization destination;
a first information processing system that performs a standard synchronization that synchronizes information with a synchronization destination by communicating with the synchronization destination at predetermined time intervals; and
a second information processing system that performs the standard synchronization,
wherein if urgent situation information is acquired from the synchronization destination with the standard synchronization performed, the first information processing system transmits to the second information processing system an execution instruction that causes to be performed an urgent synchronization that, before a next standard synchronization is performed, synchronizes information with the synchronization destination.
   (((12)))

An information processing program causing a computer to execute a process for processing information, the process comprising:

if urgent situation information is acquired from a synchronization destination when a standard synchronization to synchronize information between the information processing system and the synchronization destination is performed by communicating with the synchronization destination at predetermined time intervals,
transmitting, to a second information processing system that performs the standard synchronization, an execution instruction that causes to be performed an urgent synchronization that, before a next standard synchronization is performed, communicates with the synchronization destination and synchronizes information with the synchronization destination.

What is claimed is:

1. An information processing system comprising:
a processor configured to:
if urgent situation information is acquired from a synchronization destination when a standard synchronization to synchronize information between the information processing system and the synchronization destination is performed by communicating with the synchronization destination at predetermined time intervals,
transmit, to a second information processing system that performs the standard synchronization, an execution instruction that causes to be performed an urgent synchronization that, before a next standard synchronization is performed, communicates with the synchronization destination and synchronizes information with the synchronization destination.

2. The information processing system according to claim 1, wherein the information processing system forms a group with the second information processing system connected to a closed network that a specific information processing system is connectable to, and
wherein the processor is configured to:
if the urgent situation information is acquired from the synchronization destination with the standard synchronization performed,
transmit the execution instruction via the network to the second information processing system belonging to the group.

3. The information processing system according to claim 2, wherein the processor is configured to:
perform the standard synchronization at a timing off a timing when the second information processing system belonging to the group performs the standard synchronization.

4. The information processing system according to claim 1, wherein the processor is configured to:
perform the urgent synchronization if the execution instruction to cause the urgent synchronization to be performed is acquired from the second information processing system that executes the standard synchronization.

5. The information processing system according to claim 1, wherein the processor is configured to:
if the urgent situation information is acquired from the synchronization destination with the standard synchronization performed,
not perform the urgent synchronization when the execution instruction related to the urgent situation information is acquired from the second information processing system that performs the standard synchronization.

6. The information processing system according to claim 1, wherein the processor is configured to:
if the urgent situation information and additional information added to the urgent situation information are acquired from the synchronization destination with the standard synchronization performed,
transmit the additional information together with the execution instruction to the second information processing system.

7. The information processing system according to claim 6, wherein the additional information is a modification instruction to modify a setting on the information processing system.

8. The information processing system according to claim 6, wherein the additional information is a certificate used in communication with the synchronization destination.

9. The information processing system according to claim 6, wherein the additional information is a rule used to perform the urgent synchronization.

10. The information processing system according to claim 9, wherein the rule is an instruction to make a timing of performing the urgent synchronization different from the second information processing system to an information processing system different from the second information processing system.

11. An information synchronization system comprising:
a synchronization destination;
a first information processing system that performs a standard synchronization that synchronizes information with a synchronization destination by communicating with the synchronization destination at predetermined time intervals; and
a second information processing system that performs the standard synchronization,
wherein if urgent situation information is acquired from the synchronization destination with the standard synchronization performed, the first information processing system transmits to the second information processing system an execution instruction that causes to be performed an urgent synchronization that, before a next standard synchronization is performed, synchronizes information with the synchronization destination.

12. A non-transitory computer readable medium storing a program causing a computer to execute a process for processing information, the process comprising:
if urgent situation information is acquired from a synchronization destination when a standard synchronization to synchronize information between the information processing system and the synchronization destination is performed by communicating with the synchronization destination at predetermined time intervals,
transmitting, to a second information processing system that performs the standard synchronization, an execution instruction that causes to be performed an urgent synchronization that, before a next standard synchronization is performed, communicates with the synchronization destination and synchronizes information with the synchronization destination.
